(19) United States
(12) Patent Application Publication
(10) Pub. No.: US 2026/0097774 A1
(43) Pub. Date: Apr. 9, 2026

(54) METHOD FOR CALCULATING COORDINATION CONTROL WEIGHTS IN DISTRIBUTED DRIVE ELECTRIC VEHICLES

(71) Applicant: CHANG'AN UNIVERSITY, Xi'an (CN)

(72) Inventors: Xuan ZHAO, Xi'an (CN); Shu WANG, Xi'an (CN); Xiaolei YUAN, Xi'an (CN); Jian MA, Xi'an (CN); Rong HUANG, Xi'an (CN); Yigao NING, Xi'an (CN); Man YU, Xi'an (CN); Yilin HE, Xi'an (CN); Kai ZHANG, Xi'an (CN)

(21) Appl. No.: 19/415,704

(22) Filed: Dec. 10, 2025

Related U.S. Application Data
(63) Continuation of application No. PCT/CN2024/142091, filed on Dec. 25, 2024.

(30) Foreign Application Priority Data
Aug. 8, 2024 (CN) 202411081966.2

(51) Int. Cl. B60W 50/00; G06F 17/11

(52) U.S. Cl. CPC B60W 50/00; G06F 17/11; B60W 2050/0025

(57) ABSTRACT

A method for calculating coordination control weights in a distributed drive electric vehicle includes: vehicle motion state data is classified into three categories—stable state, transition state, and unstable state; weight factors are determined based on Euclidean distances between cluster centers of different categories; an objective function for an AFS/DYC coordination controller is constructed using the weight factors; optimal weight factors for an AFS system and a DYC system are ultimately obtained by solving the objective function.

### CROSS-REFERENCE TO RELATED APPLICATIONS

This application is a continuation of International Patent Application No. PCT/CN2024/142091, filed on Dec. 25, 2024, which claims the benefit of priority from Chinese Patent Application No. 202411081966.2, filed on Aug. 8, 2024. The content of the aforementioned application, including any intervening amendments made thereto, is incorporated herein by reference in its entirety.

### TECHNICAL FIELD

This application relates to automotive control, and more particularly to a method for calculating coordination control weights in distributed drive electric vehicles.

### BACKGROUND

As advanced active safety control systems, both Active Front Steering (AFS) and Direct Yaw Moment Control (DYC) can be utilized to enhance vehicle handling stability. When the vehicle operates within the stable region, the DYC system tends to cause longitudinal speed fluctuations, degrading ride comfort. In contrast, the AFS system offers faster response speed and control effectiveness. To improve vehicle handling performance, it is necessary to increase the control weights of the AFS system. When the vehicle is in an unstable region, tire lateral forces approach saturation, leading to reduced control precision of the AFS system, which fails to meet stability control requirements under such conditions. To enhance lateral stability, the control weights of the DYC system must be increased. Therefore, a high-speed and accurate method for calculating the coordination control weights between the AFS and DYC systems is critical, as it determines the intervention and withdrawal timing of the active safety control system, playing a significant role in improving vehicle driving safety.

Current research on coordination control weights for vehicle stability systems primarily relies on phase plane theory to assess vehicle stability states and calculates the coordination control weights based on phase plane instability errors. The stable regions are typically delineated using regular shapes such as straight lines, circles, or diamonds, which represent a simplified form of stability boundaries and cannot fully represent the actual stability limits. Furthermore, in the phase plane, criteria related to lateral stability are mainly represented by specific characteristic values, such as yaw rate or sideslip angle, resulting in weak data foundations and single characteristic parameters.

### SUMMARY

In view of the deficiencies in the prior art, this application provides a method for calculating coordination control weights in distributed drive electric vehicles. Technical solutions of the present disclosure are described as follows.

In a first aspect, this application provides a method for calculating coordination control weights in a distributed drive electric vehicle, comprising:
(a) constructing a vehicle motion state dataset; wherein a vehicle motion state data in the vehicle motion state dataset is characteristic parameters related to a lateral stability state;
(b) performing a cluster analysis on the vehicle motion state data; dividing the vehicle motion state data into three categories: a stable state category, a transition state category, and an unstable state category, and determining a cluster center for each of the three categories;
(c) determining a midpoint of a line connecting the cluster center of the stable state category and the cluster center of the transition state category, and calculating a Euclidean distance between the midpoint and the cluster center of the stable state category, denoted as the first distance; and calculating a Euclidean distance between the cluster center of the stable state category and the cluster center of the transition state category, denoted as a second distance; and
calculating a Euclidean distance between the cluster center of the stable state category and the cluster center of the unstable state category, denoted as a third distance; and calculating a Euclidean distance between a current vehicle motion state data and the cluster center of the stable state category, denoted as a fourth distance;
(d) determining weight factors for an objective function of an Active Front Steering/Direct Yaw moment Control (AFS/DYC) coordination controller based on a relationship between the first distance, the second distance, the third distance, and the fourth distance;
(e) constructing the objective function of the AFS/DYC coordination controller using the weight factors; and
(f) solving the objective function of the AFS/DYC coordination controller to obtain optimal weight factors for an AFS system and a DYC system.

In an embodiment, the characteristic parameters related to the lateral stability state comprises a longitudinal velocity, a steering wheel angle, a lateral velocity, the sideslip angle, a roll angle, the yaw angular velocity, a roll rate, a lateral acceleration, a front axle load transfer rate, and a rear axle load transfer rate.

In an embodiment, in step (d), the weight factors are determined by a following formula, expressed as:

$${λ}_{1} ,$$

$${λ}_{2} = \{ \begin{matrix}0.5 , 0.25 & & if {xx}_{1} < {L}_{1} ; \\ 0.5 - 0.5 * \frac{{( {xx}_{1} - {L}_{1} )}^{2}}{{( {L}_{1} - {L}_{2} )}^{2}} , & 0.75 - {λ}_{1} & if {L}_{1} < {xx}_{1} < \frac{( {L}_{1} - {L}_{2} )}{2} ; \\ 0.25 + 0.5 * {( 1 - \frac{{xx}_{1} - {L}_{1}}{{L}_{2} - {L}_{1}} )}^{2} , & 0.75 - {λ}_{1} & if \frac{( {L}_{1} - {L}_{2} )}{2} < {xx}_{1} < {L}_{2} ; \\ 0.25 , 0.5 - 0.5 * \frac{{( {xx}_{1} - {L}_{2} )}^{2}}{{( {L}_{3} - {L}_{2} )}^{2}} & & if {L}_{2} < {xx}_{1} < \frac{( {L}_{2} - {L}_{3} )}{2} ; \\ 0.25 , 0.25 + 0.5 * ( 1 - \frac{{xx}_{1} - {L}_{2}}{{L}_{3} - {L}_{2}} ) & & if \frac{( {L}_{2} - {L}_{3} )}{2} < {xx}_{1} < {L}_{3} ; \\ 0.25 , 0.25 & & if {xx}_{1} > {L}_{3}\end{matrix} ;$$

$${λ}_{3} = 1 - {λ}_{1} - {λ}_{2} ;$$

and
wherein λ₁ represents a weight factor related to a lateral displacement; λ₂ represents a weight factor related to a yaw angular velocity; λ₃ represents a weight factor related to a sideslip angle; xx₁ is the fourth distance; L₁ is the first distance; L₂ is the second distance; L₃ is the third distance.

In an embodiment, the objective function of the AFS/DYC coordination controller is expressed by a following formula:

$$J = \sqrt{{λ}_{1} {\sum }_{i = 1}^{N} \frac{\vert {e}_{d i} \vert}{N \vert {e}_{dmax} \vert} + {λ}_{2} {\sum }_{i = 1}^{N} \frac{\vert {β}_{i} - {β}_{r e f} \vert}{N \vert {β}_{max} \vert} + {λ}_{3} {\sum }_{i = 1}^{N} \frac{\vert {w}_{i} - {w}_{r e f} \vert}{N \vert {w}_{max} \vert}}$$

wherein J represents an objective function value; λ₁ represents the weight factor related to the lateral displacement; λ₂ represents the weight factor related to the yaw angular velocity; λ₃ represents the weight factor related to the sideslip angle; N is a number of sampling instants; e_{di} is a lateral displacement deviation at an i-th sampling instant; e_{dmax} is a maximum lateral displacement deviation; βᵢ is a sideslip angle at the i-th sampling instant; β_{ref} is a reference sideslip angle; βₘₐₓ is a maximum sideslip angle; wᵢ is a yaw angular velocity at the i-th sampling instant; w_{ref} is a reference yaw angular velocity; and wₘₐₓ is a maximum yaw angular velocity; and

e_{di}, βᵢ, and wᵢ are determined according to a discrete vehicle motion differential equation which is related to the optimal weight factor of the AFS system

In an embodiment, a K-means Density Peak Clustering (KDPC) algorithm is employed to perform the cluster analysis on the vehicle motion state data

In an embodiment, a particle swarm optimization algorithm is employed to solve the objective function of the AFS/DYC coordination controller.

In a second aspect, this application provides a device for calculating coordination control weights in a distributed drive electric vehicle, comprising: a dataset construction module, a category classification module, a distance calculation module, a weight factor determination module, an objective function construction module, and a solution module;
the dataset construction module is configured for constructing a vehicle motion state dataset; wherein a vehicle motion state data in the vehicle motion state dataset is characteristic parameters related to a lateral stability state;
the category classification module is configured for performing a cluster analysis on the vehicle motion state data; dividing the vehicle motion state data into three categories: a stable state category, a transition state category, and an unstable state category, and determining a cluster center for each of the three categories;
the distance calculation module is configured for determining a midpoint of a line connecting the cluster center of the stable state category and the cluster center of the transition state category, and calculating a Euclidean distance between the midpoint and the cluster center of the stable state category, denoted as the first distance; and calculating a Euclidean distance between the cluster center of the stable state category and the cluster center of the transition state category, denoted as a second distance; and
calculating a Euclidean distance between the cluster center of the stable state category and the cluster center of the unstable state category, denoted as a third distance;
and calculating a Euclidean distance between a current vehicle motion state data and the cluster center of the stable state category, denoted as a fourth distance;
the weight factor determination module is configured for determining weight factors for an objective function of an Active Front Steering/Direct Yaw moment Control (AFS/DYC) coordination controller based on a relationship between the first distance, the second distance, the third distance, and the fourth distance;
the objective function construction module is configured for constructing the objective function of the AFS/DYC coordination controller using the weight factors; and
the solution module is configured for solving the objective function of the AFS/DYC coordination controller to obtain optimal weight factors for an AFS system and a DYC system.

In a third aspect, this application provides a computer-readable storage medium, wherein the computer-readable storage medium stores a computer program, and the computer program is configured to be executed by a processor to implement the method above.

In a fourth aspect, this application provides a computer program product, wherein the computer program product comprises computer program/instructions, and the computer program/instructions are configured to be executed by a processor to implement the method.

Compared to the prior art, the present disclosure has the following beneficial effects.

This application classifies vehicle motion states into three categories-stable state, transition state, and unstable state, and determines weight factors based on the Euclidean distances between cluster centers of the different categories. The objective function for the AFS/DYC coordination controller is constructed using the weight factors. The optimal weight factors for the AFS system and DYC system are ultimately obtained by solving the objective function, thereby meeting vehicle stability control requirements and enhancing the vehicle's lateral stability.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

This present disclosure can be better understood by reference to the following detailed description in conjunction with the accompanying drawings, which are incorporated into and constitute a part of this specification and are included herein.

FIG. 1 shows a flowchart of a method for calculating coordination control weights in a distributed drive electric vehicle according to an embodiment of the present disclosure;

FIG. 2 is a schematic diagram of steering wheel angle;

FIG. 3 is a distribution diagram of data point clustering results;

FIG. 4 shows simulation results of coordination control weights for distributed drive electric vehicles; and

FIG. 5 is a structural block diagram of a device for calculating coordination control weights in a distributed drive electric vehicle according to an embodiment of the present disclosure.

### DETAILED DESCRIPTION OF EMBODIMENTS

Embodiments of the present disclosure will be described below with reference to the accompanying drawings. For clarity and conciseness, not all features of embodiments are described in this disclosure. However, it should be understood that numerous embodiment-specific decisions may be made during the development of embodiments in order to achieve the specific objectives, and that these decisions may vary from one embodiment to another.

It should also be noted that, in order to avoid unnecessary details in the present disclosure, the accompanying drawings only show structures that are closely related to the solution of the present disclosure, while omitting other details that are less relevant.

It should be understood that the present disclosure is not limited to the embodiments described. In this disclosure, where feasible, embodiments may be combined with each other, features may be exchanged between different embodiments, and one or more features may be omitted in an embodiment.

Numerous vehicle attribute parameters can reflect lateral stability, such as longitudinal velocity, front wheel steering angle, lateral acceleration. Therefore, the present disclosure provides a method for calculating coordination control weights in distributed drive electric vehicles. This method aims to comprehensively analyze multiple attribute parameters related to handling stability through the K-means density peak clustering (KDPC) algorithm, classify stability types, and calculate optimal weight factors for the Active Front Steering (AFS) system and the Direct Yaw moment Control (DYC) system in real-time based on the Particle Swarm Optimization (PSO) algorithm.

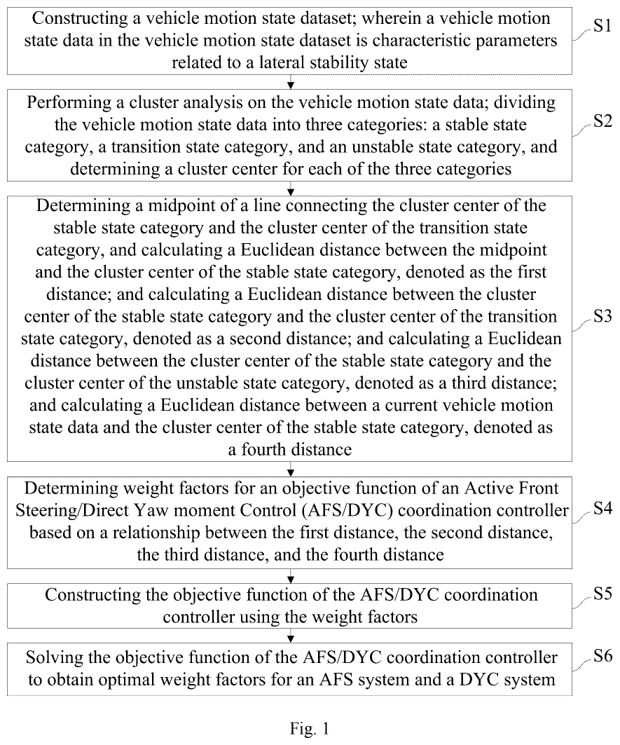

FIG. 1 shows a flowchart of the method for calculating coordination control weights in distributed drive electric vehicles.

Referring to FIG. 1, the method includes the following steps (1)-(6).

### Step (1)

A vehicle motion state dataset is constructed. The vehicle motion state data in the vehicle motion state dataset is characteristic parameters related to the lateral stability status.

A steering wheel angle step input test is conducted based on a ten-degree-of-freedom vehicle driving simulator. The step input test collects longitudinal, lateral, and vertical motion state information of vehicles under different front wheel steering angles and different driving speeds to construct the vehicle motion state dataset.

Driving simulators offer high safety and allow design of arbitrary experimental scenarios as needed without weather constraints. The driving simulators offer greater flexibility compared to real vehicle experiments while trending good consistency in driver behavior between both data collection methods. Therefore, vehicle motion state dataset is collected using PreScan, MATLAB/Simulink, and the Logitech G29 driving simulator. PreScan provides virtual driving environment to establish standardized vehicle test simulation scenarios. MATLAB/Simulink builds the vehicle dynamics model encompassing 10 degrees of freedom: longitudinal, lateral, vertical, yaw, roll, pitch, and tire motion. The Logitech G29 driving simulator primarily collects driver steering wheel angle, acceleration, and brake pedal opening signals to simulate real-vehicle driving behavior.

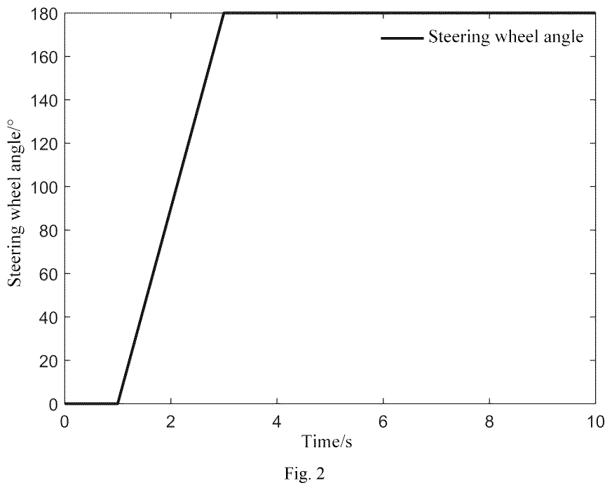

This implementation considers operational behaviors from drivers with different driving styles. 27 drivers (23 male, 4 female) conduct simulator tests at various driving speeds. The test conditions follow standard handling stability test scenario. After extensive debugging, FIG. 2 shows a schematic diagram of the steering wheel angle, starting from zero and gradually increasing to 180 degrees after 1 second. The longitudinal speed is set from 30 km/h to 120 km/h, with speed intervals of 10 km/h.

To comprehensively consider vehicle motion states, the collected characteristic parameters associated with lateral stability state include the longitudinal velocity, the steering wheel angle, the lateral velocity, the sideslip angle, the roll angle, the yaw angular velocity, the roll rate, the lateral acceleration, the front axle load transfer rate, and the rear axle load transfer rate.

The sampling frequency is set to 0.05 seconds, and the simulation time is set to 10 seconds. Ultimately, the vehicle motion state dataset under different vehicle speeds and steering angle inputs is established, including a total of 3825 data groups. The vehicle motion state dataset is defined as X and represented as:

$$\{ \begin{matrix}X = \{ {X}_{1} , {X}_{2} , … {X}_{i} … , {X}_{m} \} \\ {X}_{i} = \{ {y}_{i 1} , {y}_{i 2} , … {y}_{ij} … , {y}_{iD} \}\end{matrix} .$$

Xᵢ represents the i-th data group, m is the number of data groups, yᵢⱼ represents the j-th dimension data in Xᵢ, and D is the number of dimensions. In this embodiment, D=10.

Considering the different units and dimensions of different vehicle state parameters, and in order to generalize the distribution range of the samples, the sample data is normalized to the range [0, 1] using a normalization method. Normalizing Xᵢ yields the normalized vehicle motion state data xᵢ as follows:

$${x}_{i} = ( {x}_{i 1} , {x}_{i 2} , … {x}_{i j} … , {x}_{i D} )$$

$${x}_{i j} = \frac{{y}_{i j} - {y}_{j \_ min}}{{y}_{j \_ max} - {y}_{j \_ min}} .$$

In above formulas, xᵢⱼ represents the j-th dimension data in xᵢ, y_{j_min} is the minimum value of the j-th dimension data in the dataset X, and y_{j_max} is the maximum value of the j-th dimension data in the dataset X.

### Step (2)

Cluster analysis is performed on the vehicle motion state data within the vehicle motion state dataset to divide the vehicle motion state data into three categories: a stable state category, a transition state category, and an unstable state category. The cluster center is determined for each category.

Specifically, the K-means Density Peak Clustering (KDPC) algorithm is employed for cluster analysis of the vehicle motion state data.

In the KDPC algorithm, DPC (Density Peak Clustering) algorithm serves as a novel density-peak-based clustering method designed to obtain initial cluster centers and the number of categories. Subsequently, the K-means algorithm is employed to update the positions of cluster centers, thereby avoiding local convergence. The specific implementation process of the KDPC algorithm is well-known in the art and is not elaborated upon here.

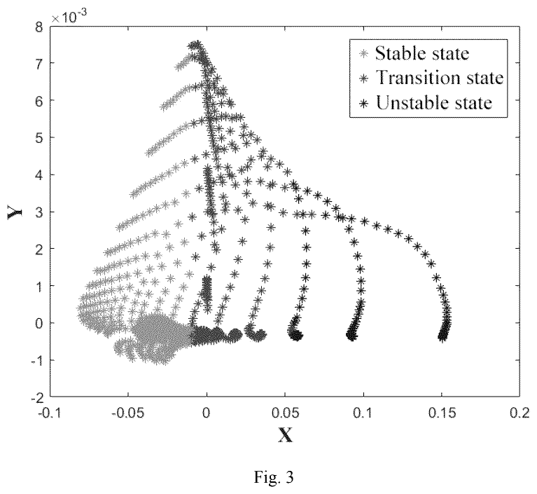

FIG. 3 is the distribution diagram of data point clustering results. As shown in FIG. 3, the data points are sequentially divided into three distinct clusters distributed across various regions in the plot. Green data points in the leftmost region indicate vehicles in the “stable state”. As the vehicle speed and steering wheel angle increase, vehicles successively enter the red “transition state” and the blue “unstable state”.

### Step (3)

The midpoint on the line connecting the cluster center of the stable state category and the cluster center of the transition state category is determined. The Euclidean distance between the midpoint and the cluster center of the stable state category is calculated and recorded as the first distance. The Euclidean distance between the cluster center of the stable state category and the cluster center of the transition state category is calculated and recorded as the second distance. The Euclidean distance between the cluster center of the stable state category and the cluster center of the unstable state category is calculated and recorded as the third distance. The Euclidean distance between the current vehicle motion state data and the cluster center of the stable state category is calculated and recorded as the fourth distance.

### Step (4)

Weight factors in the objective function of the Active Front Steering/Direct Yaw moment Control (AFS/DYC) coordination controller are determined based on the relationships between the first distance, the second distance, the third distance, and the fourth distance.

### Step (5)

The objective function of the AFS/DYC coordination controller is constructed according to the weight factors.

### Step (6)

The objective function of the AFS/DYC coordination controller is solved to obtain optimal weight factors for the AFS system and DYC system.

Specifically, the Particle Swarm Optimization (PSO) algorithm can be employed to solve the objective function of the AFS/DYC coordination controller, thereby obtaining the optimal weight factor for the AFS system. The optimal weight factor for the DYC system is then obtained by subtracting the optimal weight factor of AFS system from 1. Here, the particle positions in the PSO algorithm are defined as the weight factors of the AFS system. As the PSO algorithm is well-known prior art in the field, its detailed implementation will not be elaborated here.

In this embodiment, the vehicle motion state is categorized into three categories: the stable state category, the transition state category, and the unstable state category. Weight factors are determined based on the Euclidean distances between the cluster centers of different categories. The objective function for the AFS/DYC coordination controller is constructed using these weight factors. The optimal weight factors for the AFS system and DYC system are ultimately obtained by solving the objective function, thereby meeting the vehicle stability control requirements and enhancing the vehicle lateral stability.

In one embodiment, when the vehicle is in a stable state, a significant stability margin exists. The primary objective of the coordination controller is to enhance vehicle path tracking accuracy. Therefore, the weight factor λ₁ associated with lateral displacement is relatively large. Similarly, when the vehicle is in a transition state, vehicle maneuverability dominates over path tracking accuracy and lateral stability performance. Consequently, the weight factor λ₂ associated with the yaw angular velocity is larger. When the vehicle enters an unstable state, suppressing the magnitude of the sideslip angle is necessary to correct the vehicle's instability, and the weight factor λ₃ associated with the sideslip angle is larger. Specifically, in step (4), the weight factors in the objective function of the AFS/DYC coordination controller are determined based on the relationship between the first distance, the second distance, the third distance, and the fourth distance using the following formula:

$${λ}_{1} ,$$

$${λ}_{2} = \{ \begin{matrix}0.5 , 0.25 & & if {xx}_{1} < {L}_{1} ; \\ 0.5 - 0.5 * \frac{{( {xx}_{1} - {L}_{1} )}^{2}}{{( {L}_{1} - {L}_{2} )}^{2}} , & 0.75 - {λ}_{1} & if {L}_{1} < {xx}_{1} < \frac{( {L}_{1} - {L}_{2} )}{2} ; \\ 0.25 + 0.5 * {( 1 - \frac{{xx}_{1} - {L}_{1}}{{L}_{2} - {L}_{1}} )}^{2} , & 0.75 - {λ}_{1} & if \frac{( {L}_{1} - {L}_{2} )}{2} < {xx}_{1} < {L}_{2} ; \\ 0.25 , 0.5 - 0.5 * \frac{{( {xx}_{1} - {L}_{2} )}^{2}}{{( {L}_{3} - {L}_{2} )}^{2}} & & if {L}_{2} < {xx}_{1} < \frac{( {L}_{2} - {L}_{3} )}{2} ; \\ 0.25 , 0.25 + 0.5 * ( 1 - \frac{{xx}_{1} - {L}_{2}}{{L}_{3} - {L}_{2}} ) & & if \frac{( {L}_{2} - {L}_{3} )}{2} < {xx}_{1} < {L}_{3} ; \\ 0.25 , 0.25 & & if {xx}_{1} > {L}_{3}\end{matrix} ;$$

$${λ}_{3} = 1 - {λ}_{1} - {λ}_{2} ;$$

and

In above formula, λ₁ represents the weight factor related to the lateral displacement; λ₂ represents the weight factor related to the yaw angular velocity; λ₃ represents the weight factor related to the sideslip angle; xx₁ is the fourth distance; L₁ is the first distance; L₂ is the second distance; L₃ is the third distance. In one embodiment, the objective function of the AFS/DYC coordination controller is expressed by the following formula:

$$J = \sqrt{{λ}_{1} {\sum }_{i = 1}^{N} \frac{\vert {e}_{d i} \vert}{N \vert {e}_{dmax} \vert} + {λ}_{2} {\sum }_{i = 1}^{N} \frac{\vert {β}_{i} - {β}_{r e f} \vert}{N \vert {β}_{max} \vert} + {λ}_{3} {\sum }_{i = 1}^{N} \frac{\vert {w}_{i} - {w}_{r e f} \vert}{N \vert {w}_{max} \vert}}$$

In above formula, J represents the objective function value; λ₁ represents the weight factor related to the lateral displacement; λ₂ represents the weight factor related to the yaw angular velocity; λ₃ represents the weight factor related to the sideslip angle; N is the number of sampling instants; e_{di} is the lateral displacement deviation at the i-th sampling instant; e_{dmax} is the maximum lateral displacement deviation; βᵢ is the sideslip angle at the i-th sampling instant; β_{ref} is the reference sideslip angle; βₘₐₓ is the maximum sideslip angle; wᵢ is the yaw angular velocity at the i-th sampling instant; w_{ref} is the reference yaw angular velocity; and wₘₐₓ is the maximum yaw angular velocity.

e_{di}, βᵢ, and wᵢ are determined according to a discrete vehicle motion differential equation which is related to the optimal weight factor of the AFS system. Specifically, they can be determined using the following formula:

$${z}^{*} ( i + 1 ) = {E}^{*} {z}^{*} ( i ) + {F}_{1}^{*} P {δ}_{f} ( i ) + {F}_{2}^{*} ( 1 - P ) Δ M ( i ) + {D}^{*} {\dot{Ψ}}_{d}$$

$$\{ \begin{matrix}{z}^{*} = [ \begin{matrix}{e}_{d} \\ {e}_{ψ} \\ β \\ w\end{matrix} ] , {F}_{1}^{*} = [ \begin{matrix}0 \\ 0 \\ {b}_{11} \\ {b}_{21}\end{matrix} ] , {F}_{2}^{*} = [ \begin{matrix}0 \\ 0 \\ 0 \\ 1 / {I}_{z}\end{matrix} ] \\ {E}^{*} = [ \begin{matrix}0 & {v}_{x} & {v}_{x} & 0 \\ 0 & 0 & 0 & 1 \\ 0 & 0 & {a}_{11} & {a}_{12} \\ 0 & 0 & {a}_{21} & {a}_{22}\end{matrix} ] , {D}^{*} = [ \begin{matrix}0 \\ - 1 \\ 0 \\ 0\end{matrix} ]\end{matrix}$$

$${a}_{11} = - \frac{{k}_{1} + {k}_{2}}{m {v}_{x}} , {a}_{12} = \frac{b {k}_{2} - a {k}_{1}}{m {v}_{x}^{2}} - 1 , {a}_{21} = \frac{b {k}_{2} - a {k}_{1}}{{I}_{z}} , {a}_{22} = - \frac{{a}^{2} {k}_{1} + {b}^{2} {k}_{2}}{{I}_{z} {v}_{x}} .$$

$${b}_{11} = {k}_{1} / {mv}_{x} , {b}_{12} = {k}_{2} / {mv}_{x} , {b}_{21} = a {k}_{1} / {I}_{z} , {b}_{22} = - b {k}_{2} / {I}_{z}$$

In above formula, z* represents vehicle motion state information, i denotes the sampling instant, e_{d} is the lateral displacement deviation, e_{ψ} is the heading angle deviation, β is the sideslip angle, w is the yaw angular velocity,

$${F}_{1}^{*} , {F}_{2}^{*} ,$$

and D* are coefficient matrices, and b₁₁, b₂₁, a₁₁, a₁₂, a₂₁, and a₂₂ are all dynamic model parameters; vₓ is the vehicle longitudinal velocity, I_{z} is the vehicle moment of inertia about the z-axis, k₁ and k₂ are the cornering stiffnesses of the front and rear wheels, respectively; m is the vehicle mass; a and b are the distances from the vehicle's center of gravity to the front and rear axles, respectively; P is the weight coefficient of the AFS system; ΔM is the additional yaw moment; Ψ_{d} is the reference heading angle; δ_{f} is the front wheel steering angle.

The reference yaw angular velocity w_{ref} is expressed as:

$${w}_{ref} = min \{ \frac{{v}_{x} {δ}_{f}}{( 1 + K {v}_{x}^{2} ) l} , \frac{0.85 μ g}{{v}_{x}} \} .$$

In above formula, K is the vehicle stability coefficient, l is the wheelbase, l=a+b, μ is the road adhesion coefficient, and g is the gravitational acceleration.

The reference sideslip angle β_{ref} is expressed as:

$${β}_{ref} = min \{ \frac{b + {mav}_{x}^{2} / ( {k}_{2} l )}{l ( 1 + {Kv}_{x}^{2} )} {δ}_{f} , ( \frac{b}{{v}_{x}^{2}} + \frac{m a}{{k}_{2} l} ) μ g \} .$$

To further verify the effectiveness of the proposed method, a single-lane-change scenario was implemented as the test scenario. Simulation experiments were conducted at a driving speed of 80 km/h on a road surface with a road adhesion coefficient of 0.3, with the coordination control weights used in these simulations providing further illustration.

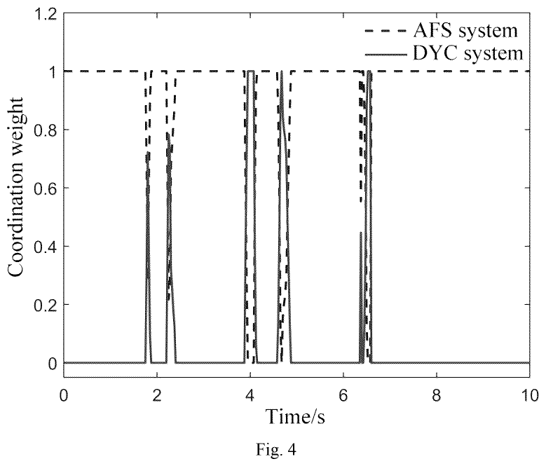

FIG. 4 showed the simulation results of coordination control weights for distributed drive electric vehicles. According to FIG. 4, the AFS system weighting was predominant when the vehicle operated in the stable region. When the vehicle entered the unstable region, both AFS and DYC weightings fluctuate significantly, jointly collaboratively the vehicle's handling stability.

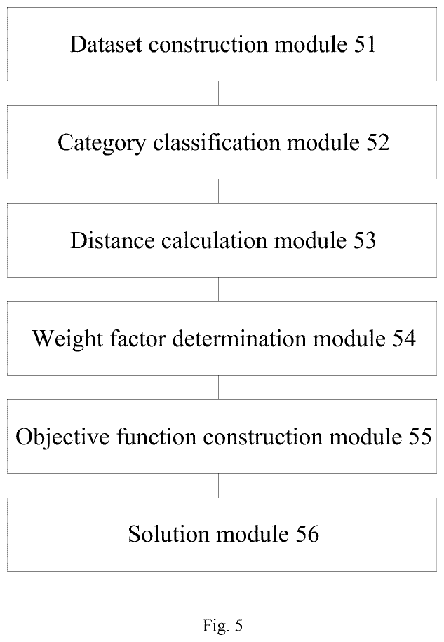

Based on the same inventive concept as the method for calculating coordination control weights in distributed drive electric vehicles, this embodiment also provides a corresponding device for calculating coordination control weights. FIG. 5 shows a structural block diagram of the device for calculating coordination control weights in distributed drive electric vehicles. The device includes a dataset construction module 51, a category classification module 52, a distance calculation module 53, a weight factor determination module 54, an objective function construction module 55, and a solution module 56.

The dataset construction module 51 is configured for constructing the vehicle motion state dataset. The vehicle motion state data in the vehicle motion state dataset is characteristic parameters related to the lateral stability state.

The category classification module 52 is configured for performing cluster analysis on the vehicle motion state data; dividing the vehicle motion state data into three categories: the stable state category, the transition state category, and the unstable state category, and determining the cluster center for each of the three categories.

The distance calculation module 53 is configured for determining the midpoint of the line connecting the cluster center of the stable state category and the cluster center of the transition state category, and calculating the Euclidean distance between the midpoint and the cluster center of the stable state category, denoted as the first distance; and calculating the Euclidean distance between the cluster center of the stable state category and the cluster center of the transition state category, denoted as the second distance.

The distance calculation module 53 is further configured for calculating the Euclidean distance between the cluster center of the stable state category and the cluster center of the unstable state category, denoted as the third distance; and calculating a Euclidean distance between the current vehicle motion state data and the cluster center of the stable state category, denoted as the fourth distance.

The weight factor determination module 54 is configured for determining weight factors for an objective function of the AFS/DYC coordination controller based on the relationship between the first distance, the second distance, the third distance, and the fourth distance.

The objective function construction module 55 is configured for constructing the objective function of the AFS/DYC coordination controller using the weight factors.

The solution module 56 is configured for solving the objective function of the AFS/DYC coordination controller to obtain optimal weight factors for the AFS system and the DYC system.

The device for calculating coordination control weights in distributed drive electric vehicles in this embodiment shares the same inventive concept as the method described above. Therefore, specific implementations of the device may be derived from the embodiments of the aforementioned method for calculating coordination control weights. The technical effects correspond to those of the method. These details will not be repeated here.

The present disclosure also provides a computer-readable storage medium storing a computer program which, when executed by a processor, causes the processor to implement the aforementioned method for calculating coordination control weights in distributed drive electric vehicles.

The present disclosure also provides a computer program product including computer program/instructions which, when executed by a processor, cause the processor to implement the aforementioned method for calculating coordination control weights in distributed drive electric vehicles.

Described above are merely preferred embodiments of the disclosure, which are not intended to limit the disclosure. It should be understood that any modifications and replacements made by those skilled in the art without departing from the spirit of the disclosure should fall within the scope of the disclosure defined by the appended claims.

What is claimed is:

1. A method for calculating coordination control weights in a distributed drive electric vehicle, comprising:
(a) constructing a vehicle motion state dataset; wherein a vehicle motion state data in the vehicle motion state dataset is characteristic parameters related to a lateral stability state;
(b) performing a cluster analysis on the vehicle motion state data; dividing the vehicle motion state data into three categories: a stable state category, a transition state category, and an unstable state category, and determining a cluster center for each of the three categories;
(c) determining a midpoint of a line connecting the cluster center of the stable state category and the cluster center of the transition state category, and calculating a Euclidean distance between the midpoint and the cluster center of the stable state category, denoted as the first distance; and calculating a Euclidean distance between the cluster center of the stable state category and the cluster center of the transition state category, denoted as a second distance; and
calculating a Euclidean distance between the cluster center of the stable state category and the cluster center of the unstable state category, denoted as a third distance; and calculating a Euclidean distance between a current vehicle motion state data and the cluster center of the stable state category, denoted as a fourth distance;
(d) determining weight factors for an objective function of an Active Front Steering/Direct Yaw moment Control (AFS/DYC) coordination controller based on a relationship between the first distance, the second distance, the third distance, and the fourth distance;
(e) constructing the objective function of the AFS/DYC coordination controller using the weight factors; and
(f) solving the objective function of the AFS/DYC coordination controller to obtain optimal weight factors for an AFS system and a DYC system; and
wherein in step (d), the weight factors are determined by a following formula, expressed as:
$${λ}_{1} ,$$
$${λ}_{2} = \{ \begin{matrix}0.5 , 0.25 & & if {xx}_{1} < {L}_{1} ; \\ 0.5 - 0.5 * \frac{{( {xx}_{1} - {L}_{1} )}^{2}}{{( {L}_{1} - {L}_{2} )}^{2}} , & 0.75 - {λ}_{1} & if {L}_{1} < {xx}_{1} < \frac{( {L}_{1} - {L}_{2} )}{2} ; \\ 0.25 + 0.5 * {( 1 - \frac{{xx}_{1} - {L}_{1}}{{L}_{2} - {L}_{1}} )}^{2} , & 0.75 - {λ}_{1} & if \frac{( {L}_{1} - {L}_{2} )}{2} < {xx}_{1} < {L}_{2} ; \\ 0.25 , 0.5 - 0.5 * \frac{{( {xx}_{1} - {L}_{2} )}^{2}}{{( {L}_{3} - {L}_{2} )}^{2}} & & if {L}_{2} < {xx}_{1} < \frac{( {L}_{2} - {L}_{3} )}{2} ; \\ 0.25 , 0.25 + 0.5 * ( 1 - \frac{{xx}_{1} - {L}_{2}}{{L}_{3} - {L}_{2}} ) & & if \frac{( {L}_{2} - {L}_{3} )}{2} < {xx}_{1} < {L}_{3} ; \\ 0.25 , 0.25 & & if {xx}_{1} > {L}_{3}\end{matrix} ;$$
$${λ}_{3} = 1 - {λ}_{1} - {λ}_{2} ;$$
and
wherein λ₁ represents a weight factor related to a lateral displacement; λ₂ represents a weight factor related to a yaw angular velocity; λ₃ represents a weight factor related to a sideslip angle; xx₁ is the fourth distance; L₁ is the first distance; L₂ is the second distance; and L₃ is the third distance; and
the objective function of the AFS/DYC coordination controller is expressed by a following formula:
$$J = \sqrt{{λ}_{1} {\sum }_{i = 1}^{N} \frac{\vert {e}_{d i} \vert}{N \vert {e}_{dmax} \vert} + {λ}_{2} {\sum }_{i = 1}^{N} \frac{\vert {β}_{i} - {β}_{r e f} \vert}{N \vert {β}_{max} \vert} + {λ}_{3} {\sum }_{i = 1}^{N} \frac{\vert {w}_{i} - {w}_{r e f} \vert}{N \vert {w}_{max} \vert}}$$
wherein J represents an objective function value; λ₁ represents the weight factor related to the lateral displacement; λ₂ represents the weight factor related to the yaw angular velocity; λ₃ represents the weight factor related to the sideslip angle; N is a number of sampling instants; e_{di} is a lateral displacement deviation at an i-th sampling instant; e_{dmax} is a maximum lateral displacement deviation; βᵢ is a sideslip angle at the i-th sampling instant; β_{ref} is a reference sideslip angle; βₘₐₓ is a maximum sideslip angle; wᵢ is a yaw angular velocity at the i-th sampling instant; w_{ref} is a reference yaw angular velocity; and wₘₐₓ is a maximum yaw angular velocity; and
e_{di}, βᵢ, and wᵢ are determined according to a discrete vehicle motion differential equation which is related to the optimal weight factor of the AFS system.

2. The method of claim 1, wherein the characteristic parameters related to the lateral stability state comprises a longitudinal velocity, a steering wheel angle, a lateral velocity, the sideslip angle, a roll angle, the yaw angular velocity, a roll rate, a lateral acceleration, a front axle load transfer rate, and a rear axle load transfer rate.

3. The method of claim 1, wherein a K-means Density Peak Clustering (KDPC) algorithm is employed to perform the cluster analysis on the vehicle motion state data.

4. The method of claim 1, wherein a particle swarm optimization algorithm is employed to solve the objective function of the AFS/DYC coordination controller.

5. A device for calculating coordination control weights in a distributed drive electric vehicle, comprising:
a dataset construction module;
a category classification module;
a distance calculation module;
a weight factor determination module;
an objective function construction module; and
a solution module;
the dataset construction module is configured for constructing a vehicle motion state dataset; wherein a vehicle motion state data in the vehicle motion state dataset is characteristic parameters related to a lateral stability state;
the category classification module is configured for performing a cluster analysis on the vehicle motion state data; dividing the vehicle motion state data into three categories: a stable state category, a transition state category, and an unstable state category, and determining a cluster center for each of the three categories;
the distance calculation module is configured for determining a midpoint of a line connecting the cluster center of the stable state category and the cluster center of the transition state category, and calculating a Euclidean distance between the midpoint and the cluster center of the stable state category, denoted as the first distance; and calculating a Euclidean distance between the cluster center of the stable state category and the cluster center of the transition state category, denoted as a second distance; and
calculating a Euclidean distance between the cluster center of the stable state category and the cluster center of the unstable state category, denoted as a third distance; and calculating a Euclidean distance between a current vehicle motion state data and the cluster center of the stable state category, denoted as a fourth distance;
the weight factor determination module is configured for determining weight factors for an objective function of an Active Front Steering/Direct Yaw moment Control (AFS/DYC) coordination controller based on a relationship between the first distance, the second distance, the third distance, and the fourth distance;
the objective function construction module is configured for constructing the objective function of the AFS/DYC coordination controller using the weight factors; and
the solution module is configured for solving the objective function of the AFS/DYC coordination controller to obtain optimal weight factors for an AFS system and a DYC system;
the weight factor determination module is further configured for determining the weight factors by a following formula expressed as:
$${λ}_{1} ,$$
$${λ}_{2} = \{ \begin{matrix}0.5 , 0.25 & & if {xx}_{1} < {L}_{1} ; \\ 0.5 - 0.5 * \frac{{( {xx}_{1} - {L}_{1} )}^{2}}{{( {L}_{1} - {L}_{2} )}^{2}} , & 0.75 - {λ}_{1} & if {L}_{1} < {xx}_{1} < \frac{( {L}_{1} - {L}_{2} )}{2} ; \\ 0.25 + 0.5 * {( 1 - \frac{{xx}_{1} - {L}_{1}}{{L}_{2} - {L}_{1}} )}^{2} , & 0.75 - {λ}_{1} & if \frac{( {L}_{1} - {L}_{2} )}{2} < {xx}_{1} < {L}_{2} ; \\ 0.25 , 0.5 - 0.5 * \frac{{( {xx}_{1} - {L}_{2} )}^{2}}{{( {L}_{3} - {L}_{2} )}^{2}} & & if {L}_{2} < {xx}_{1} < \frac{( {L}_{2} - {L}_{3} )}{2} ; \\ 0.25 , 0.25 + 0.5 * ( 1 - \frac{{xx}_{1} - {L}_{2}}{{L}_{3} - {L}_{2}} ) & & if \frac{( {L}_{2} - {L}_{3} )}{2} < {xx}_{1} < {L}_{3} ; \\ 0.25 , 0.25 & & if {xx}_{1} > {L}_{3}\end{matrix} ;$$
$${λ}_{3} = 1 - {λ}_{1} - {λ}_{2} ;$$
and
wherein λ₁ represents a weight factor related to a lateral displacement; λ₂ represents a weight factor related to a yaw angular velocity; λ₃ represents a weight factor related to a sideslip angle; xx₁ is the fourth distance; L₁ is the first distance; L₂ is the second distance; L₃ is the third distance; and
the objective function of the AFS/DYC coordination controller is expressed by a following formula:
$$J = \sqrt{{λ}_{1} {\sum }_{i = 1}^{N} \frac{\vert {e}_{d i} \vert}{N \vert {e}_{dmax} \vert} + {λ}_{2} {\sum }_{i = 1}^{N} \frac{\vert {β}_{i} - {β}_{r e f} \vert}{N \vert {β}_{max} \vert} + {λ}_{3} {\sum }_{i = 1}^{N} \frac{\vert {w}_{i} - {w}_{r e f} \vert}{N \vert {w}_{max} \vert}}$$
wherein J represents an objective function value; λ₁ represents the weight factor related to the lateral displacement; λ₂ represents the weight factor related to the yaw angular velocity; λ₃ represents the weight factor related to the sideslip angle; N is the number of sampling instants; e_{di} is a lateral displacement deviation at an i-th sampling instant; e_{dmax} is a maximum lateral displacement deviation; βᵢ is a sideslip angle at the i-th sampling instant; β_{ref} is a reference sideslip angle; βₘₐₓ is a maximum sideslip angle; wᵢ is a yaw angular velocity at the i-th sampling instant; w_{ref} is a reference yaw angular velocity; and wₘₐₓ is a maximum yaw angular velocity; and
e_{di}, βᵢ, and wᵢ are determined according to a discrete vehicle motion differential equation which is related to the optimal weight factor of the AFS system.

6. A computer-readable storage medium, wherein a computer program is stored on the computer-readable storage medium, and the computer program is configured to be executed by a processor to implement the method according to claim 1.

7. A computer program product, comprising:
computer programs/instructions;
wherein the computer programs/instructions are configured to be executed by a processor to implement the method according to claim 1.
